(19) United States
(12) Patent Application Publication
(10) Pub. No.: US 2026/0216606 A1
(43) Pub. Date: Jul. 30, 2026

(54) Multi-Port Recharge Dock for Video Game Input Devices with Translucent Dust Cover and Lighting Effects

(71) Applicant: Michael Kidakarn, Redondo Beach, CA (US)

(72) Inventor: Michael Kidakarn, Redondo Beach, CA (US)

(21) Appl. No.: 19/039,839

(22) Filed: Jan. 29, 2025

(51) Int. Cl. A63F 13/98; H02J 7/70

(52) U.S. Cl. CPC A63F 13/98; H02J 7/731

(57) ABSTRACT

The present invention provides a versatile recharger stand for video game controller input devices, equipped with multiple connection methods to support diverse port types. The recharger features snap-in metal contact plates and magnetic connector rings, ensuring compatibility with a wide range of controllers. An innovative translucent dust cover shields the device from debris while enhancing its aesthetic appeal with integrated lighting effects. These lighting effects pass through patterns, shapes, or designs on the cover, projecting colorful and dynamic visuals onto surrounding surfaces. This invention simplifies charging for users with multiple video game controllers by offering a single recharger solution that combines functionality, durability, and aesthetic customization. Its modular design ensures easy maintenance and adaptability for future port types, making it a future-proof accessory for gaming enthusiasts.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention pertains to the field of video game accessories, specifically to recharging solutions for video game controller input devices. It focuses on enhancing the compatibility of recharge docks by incorporating multiple connection methods to support various controller port types. Additionally, it integrates protective and aesthetic features, such as a translucent dust cover and customizable lighting effects.

### Description of the Related Art

In the modern gaming industry, video game controllers have become a vital component of the gaming experience. These controllers, available in various designs and functionalities, often come with distinct charging ports and connectors, creating a fragmented ecosystem of recharging solutions. Gamers frequently face challenges in managing multiple devices with incompatible ports and chargers. The invention aims to address these issues by introducing a multi-port recharger stand that combines compatibility, durability, and aesthetic appeal in a single, user-friendly solution.

Video game controllers are integral to console gaming, and their usability depends heavily on reliable power sources. With the global gaming accessories market valued at $8.2 billion in 2022 and projected to grow at a CAGR of 9.5% until 2030, innovative accessories like universal recharging stands have a significant market potential. The ability to charge multiple devices simultaneously and support various connection types not only saves time but also reduces clutter, enhancing convenience for users. Furthermore, aesthetic features like lighting effects and customizations make this invention an attractive addition to modern gaming setups.

Over 500 million console gamers worldwide own at least one gaming controller, with many owning multiple controllers due to multiplayer gaming and cross-console compatibility.

According to market reports, approximately 40% of gamers use third-party accessories, including recharging docks. However, only 15% of these docks support multiple device types. Controller replacements due to port wear-and-tear cost gamers an estimated $200 million annually, highlighting the need for better-designed and durable charging solutions.

The global trend toward personalization and gaming aesthetics has seen a 30% increase in the demand for gaming accessories with customizable features.

Previous innovations in the field of controller charging have primarily focused on single-device solutions. Companies have developed recharging docks with proprietary connectors tailored to specific controller brands, such as the PlayStation DualSense or Xbox controllers. Some have incorporated magnetic charging technologies for ease of use, while others have integrated basic lighting to indicate charging status. A few high-end solutions have explored multi-device support; however, these often lack adaptability for future devices or fail to offer user-friendly customization options.

Despite advancements, existing charging solutions exhibit several shortcomings. Most rechargers are brand-specific, forcing users with controllers from multiple platforms to purchase separate docks. Limited port types restrict compatibility, leading to frustration among gamers. Additionally, aesthetic and functional features, such as dust protection or customizable lighting, are often absent or rudimentary. Many devices lack modularity, making them difficult to upgrade or repair, and fail to address long-term usability concerns like port durability and adaptability for future technologies.

The Multi-Port Recharge Dock for Video Game Input Devices, revolutionizes the gaming accessory market by offering a universal, versatile, and aesthetically pleasing solution. Unlike traditional rechargers, this device supports multiple connection types, including snap-in metal contact plates and magnetic connector rings, ensuring compatibility with a wide range of gaming controllers. The stand's modular design allows users to replace or upgrade recharge ports, future-proofing the device. Additionally, the translucent dust cover not only protects the stand but also enhances its visual appeal with colorful lighting effects and projection capabilities.

The proposed invention addresses the critical gaps in existing solutions by combining functionality, durability, and aesthetic appeal in a single device. It eliminates the need for multiple chargers by supporting various controller types, reducing clutter and costs for users. The modular design ensures compatibility with future devices, addressing the rapid evolution of gaming hardware. Aesthetic features like customizable lighting and projection effects cater to the growing demand for personalized gaming setups. The durable, anti-scratch dust cover ensures long-term usability, addressing concerns of wear-and-tear and debris accumulation. By blending practical utility with immersive design, our invention fulfills the unmet needs of gamers while setting a new standard in the gaming accessories market.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve prior techniques and provide an advanced design wherein a single recharger stand that supports multiple video game controller port types, ensuring universal compatibility.

The invention also aims to allow users to charge multiple controllers simultaneously, enhancing convenience and reducing clutter.

A further objective of the present invention is to incorporate interchangeable adapters, enabling future compatibility with evolving video game controller technologies.

It is also an object of the invention is to include a translucent dust cover that protects the charging mechanism from dust and debris, ensuring longevity.

It is further the objective of the invention to project colorful lighting effects onto walls or ceilings, enhancing the aesthetic appeal of the gaming environment.

It is also the objective of the invention to allow users to customize patterns, shapes, or designs projected by the translucent cover, providing personalization options.

The objective of the invention is feature a mobile-controlled lighting system, enabling users to adjust colors, patterns, and brightness as desired.

It is also the objective of the invention to include a modular design, allowing easy replacement or upgrades of individual recharge ports without dismantling the entire stand.

It is further the objective of the invention to provide a durable, anti-scratch, and UV-resistant translucent dust cover, ensuring a long-lasting and visually clear appearance.

The invention aims to offer an immersive gaming experience by synchronizing the lighting effects with in-game events or audio.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates the fully deployed view of the proposed invention as per preferred embodiments of the invention.

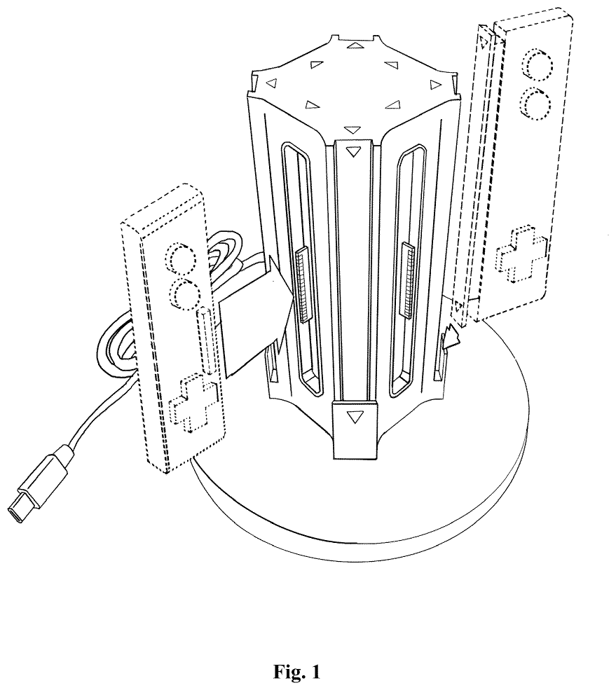

FIG. 2 illustrates the complete assembly as per preferred embodiments of the invention.

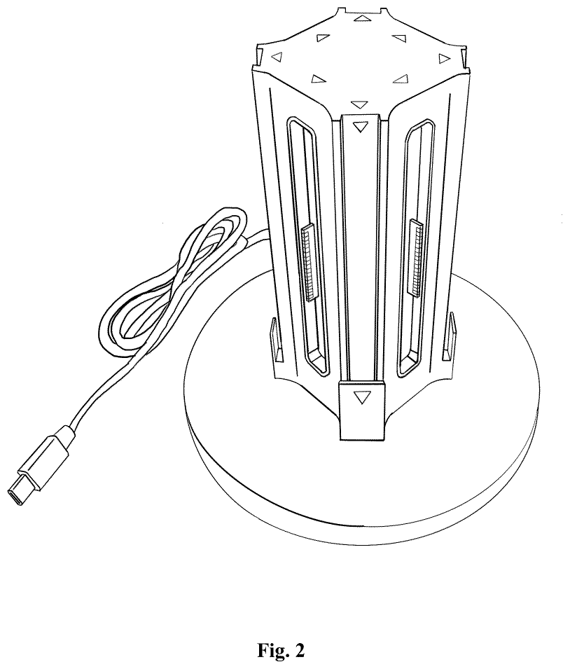

FIG. 3 illustrates the ornamental and protectional view of the assembly as per preferred embodiments of the invention.

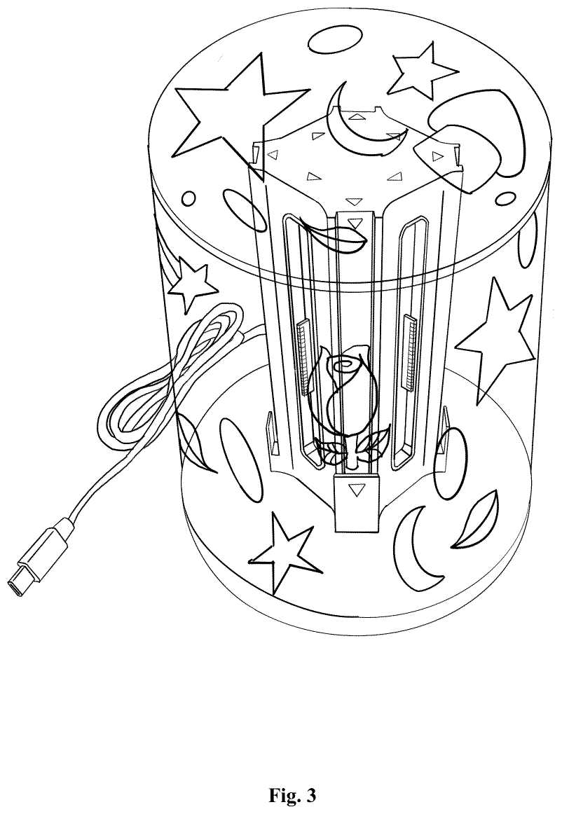

FIG. 4 shows another view of the assembly as per preferred embodiments of the invention.

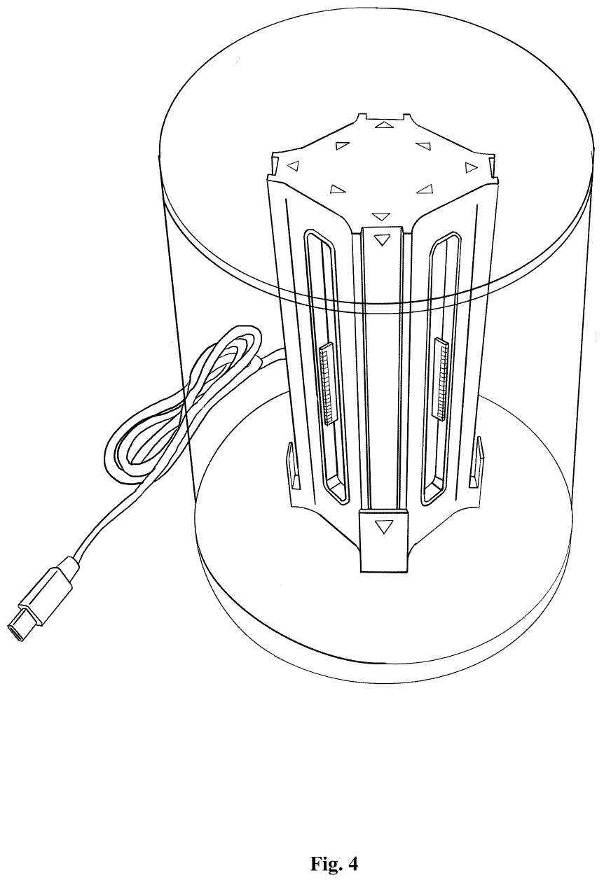

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The invention is a versatile and multi-functional recharger stand specifically designed for video game controller input devices. It incorporates multiple connection methods, such as snap-in metal contact plates and magnetic connector rings, allowing seamless charging for controllers from various brands and models. These connections ensure a stable power supply and quick setup, eliminating the need for multiple charging solutions. The stand is designed to be compatible with current and future gaming controllers, providing users with a long-term, adaptable charging solution.

As per its preferred embodiments, the recharger stand includes multiple ports integrated into a single base unit, offering compatibility with different controller connection standards. Snap-in metal contact plates ensure a secure and precise fit, while magnetic connector rings simplify the alignment process by automatically guiding the device into place. This dual-system approach not only maximizes compatibility but also provides users with the flexibility to charge a variety of devices simultaneously, regardless of their port type.

As per its further embodiments, to enhance the adaptability of the device, the recharger stand features modular recharge ports that can be easily replaced or upgraded. Interchangeable adapters are included, allowing the user to customize the stand to accommodate new or proprietary controller designs. This modularity ensures that the recharger remains functional and relevant even as gaming technology evolves, eliminating the need for frequent replacements.

As per its preferred embodiments, the recharger stand includes a translucent dust cover that serves both protective and decorative purposes. This cover shields the internal charging components and ports from dust, debris, and accidental spills, ensuring that the device remains functional over extended use. Manufactured from anti-scratch, UV-resistant material, the dust cover is highly durable and maintains its transparency over time. The sliding mechanism of the cover allows users to easily access the ports while keeping them protected when not in use.

As per its preferred embodiments, the standout feature of the invention is the integrated lighting system, which produces colorful and dynamic visual effects. The lights are embedded in the base of the recharger stand and project through the translucent dust cover. The cover itself is designed with patterns, shapes, or designs that interact with the lighting system to create visually stunning projections on walls or ceilings. These lighting effects can be used to enhance the gaming environment, creating a vibrant and immersive experience for users. The circular base of the dust cover may rotate, this will cause the light projections to move in a circle around the room.

As per its preferred embodiments, the lighting system is designed to be fully customizable via a dedicated mobile application. Users can select from a variety of colors, patterns, and lighting modes, allowing them to tailor the appearance of the recharger stand to their preferences. The app also includes advanced features such as brightness adjustment, dynamic lighting effects, and synchronization with in-game events or music. This level of customization ensures that the recharger stand not only serves a functional purpose but also enhances the aesthetic appeal of the user's gaming setup.

As per its preferred embodiments, the recharger stand is capable of supporting multiple controllers at the same time, making it an ideal solution for households or gaming setups with multiple users. Each port operates independently, ensuring that the functionality of one port is not affected by the others. This independent operation ensures a reliable charging process for all connected devices, even if some ports are not in use.

As per its preferred embodiments, the base of the recharger stand is constructed from high-quality, impact-resistant materials to ensure durability under repeated use. The ports and connectors are designed for long-term reliability, capable of withstanding thousands of connection and disconnection cycles without wear. The anti-scratch surface of the translucent dust cover prevents aesthetic degradation, while its UV-resistant properties ensure that it remains clear and free from yellowing over time.

As per its preferred embodiments, the recharger stand is designed with user convenience in mind. Its modular design allows for the easy replacement of worn or damaged components, ensuring that the device remains fully operational without requiring technical expertise. The sliding translucent dust cover ensures simple access to the recharge ports while providing a secure closure to protect them when not in use. Additionally, the lightweight and compact design make it easy to place the stand in various gaming environments without occupying excessive space.

As per its preferred embodiments, the invention seamlessly blends functionality with aesthetics, offering a visually appealing addition to gaming setups. Its colorful lighting effects, customizable projection designs, and sleek form factor make it an essential accessory for gaming enthusiasts. The recharger stand addresses the practical need for a universal charging solution while also contributing to the overall gaming experience with its immersive and engaging design.

As per its preferred embodiments, the invention represents a comprehensive solution that balances the technical requirements of device recharging with the aesthetic demands of modern gaming setups. By combining universal compatibility, modularity, and customizable features, the recharger stand enhances the user experience and ensures long-term relevance.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A video game controller input device recharger stand comprising:
A housing designed to support multiple video game controllers simultaneously;
Multiple recharge ports, each configured for different connection methods, including snap-in metal contact plates and magnetic connector rings; and
A translucent dust cover that protects the recharging area from dust while allowing light to pass through.
The recharger stand as per claim 1, wherein the multiple recharge ports include interchangeable adapters to support additional port types beyond snap-in and magnetic connections.
The recharger stand as per claim 1, wherein the assembly further comprises a modular design allowing users to replace individual recharge ports without dismantling the entire device.
The recharger stand as per claim 1, wherein the translucent dust cover is made of an anti-scratch and UV-resistant material to ensure durability and clarity over time.

2. The recharger stand wherein the translucent dust cover is equipped with embedded patterns, shapes, or designs that project colorful visuals onto walls or ceilings when illuminated.
The recharger stand as per claim 2, wherein the embedded patterns, shapes, or designs are customizable by the user to create personalized projections.
The recharger stand as per claim 2, further comprising an integrated lighting system capable of emitting multiple colors and patterns to enhance the visual experience.
The recharger stand as per claim 2, wherein the circular base of the dust cover may rotate, this will cause the light projections to move in a circle around the room.

3. The recharger stand of claim 1, further comprising an integrated lighting system capable of emitting multiple colors and patterns to enhance the visual experience.
The recharger stand as per claim 3, wherein the integrated lighting system is controlled via a mobile application that allows users to adjust colors, patterns, and intensity.
The recharger stand as per claim 3, further comprising a lighting synchronization feature that aligns with audio or game events for an immersive experience.
